(19) United States
(12) Patent Application Publication
(10) Pub. No.: US 2023/0153877 A1
(43) Pub. Date: May 18, 2023

(54) SYSTEM AND METHOD FOR OPTIMAL RESOURCE ALLOCATION THROUGH MULTI-STAGE PROCESS MANAGEMENT

(71) Applicant: David Clark, Fountain Hills, AZ (US)

(72) Inventor: David Clark, Fountain Hills, AZ (US)

(21) Appl. No.: 17/989,445

(22) Filed: Nov. 17, 2022

Related U.S. Application Data
(60) Provisional application No. 63/280,293, filed on Nov. 17, 2021.

(51) Int. Cl. G06Q 30/0601

(52) U.S. Cl. CPC G06Q 30/0605; G06Q 30/0613

(57) ABSTRACT

There is presented a multi-stage system and method for disposing of, selling, or transferring identified assets. Aspects include identifying an inventory of assets to be transferred through a multi-stage process; designating a first set of the assets for ownership transfer through a first offer process; presenting the first set of assets for purchase by a first designated recipient group through the first offer process; establishing a cut-over point to a second offer process, the cut-over point determined by a pre-determined criterion; presenting unpurchased assets of the first set of assets for purchase to a second designated group of recipients; and transferring ownership of the first set of assets to the purchasing recipients of the first and second groups. There may be any desired number of stages, such as two or more stages in the exemplary process.

### CROSS-REFERENCE TO RELATED APPLICATIONS

This application claims the benefit under 35 USC 119(e) of prior co-pending U.S. Provisional Patent Application No. 63/280,293, filed Nov. 17, 2021, the disclosure of which is hereby incorporated by reference in its entirety.

### FIELD OF THE INVENTION

The instant application relates to systems and methods for optimal resource allocation. More particularly, aspects of the present invention relate to systems and methods related to the management of golf tee time inventories.

### BACKGROUND

There are many markets where good and services are offered for sale primarily through the online eCommerce. In many cases, the goods and services are sold using standard pricing models that are inefficient—the highest demand inventory is sold at prices below what they would obtain if they used more efficient methods and the lower demand inventory does not sell at all. The result is significant missed opportunity to raise prices for high demand inventory and to increase the total sales by selling the lower demand inventories at prices where supply and demand intersect. FIG. 1 illustrates this classic scenario, showing supply and demand in online markets with inefficient pricing models.

Adobe® reported in their Sep. 15, 2021 Digital Economy Index (https://blog.adobe.com/en/publish/2021/09/15/adobe-digital-economy-index-ecommerce-hits-new-milestone-online-prices-continue-rise#gs.gj5351) that eCommerce continues to grow in popularity and these trends have accelerated with the onset and spread of the COVID pandemic. Specifically, Adobe® estimated that online sales grew 42% in 2020 and 9% comparing sales from January thru August 2021 against the corresponding sales from the prior year. Their study showed that online spending now represents $1 out of every $5 (20%) of total consumer spending. They also reported that with higher demand, prices have been increasing 31% for the 18 categories they track. Adobe® also reported that eCommerce sales are on a “pace to hit $4.2 trillion this year” (https://business.adobe.com/resources/reports/adobe-digital-economic-index-april-2021.html).

Adobe® tracks 18 categories of eCommerce spending. These categories are primarily related to goods. Amazon® sells many of these goods, for example, today. In addition, there are many other service categories where the same opportunities exist. Some examples, include but are not limited to, golf tee times, hotel rooms, vacation rentals, campground sites, etc.

There is significant academic research supporting that auction-based pricing results in higher pricing where there is a high probability of sale; one example supports this assertion in in a study electronically published Jan. 11, 2018, by Stanford, Harvard, and Microsoft researchers in their paper “Auctions versus Posted Prices in Online Markets” Stanford: https://web.stanford.edu/˜leinav/pubs/JPE2018.pdf). FIG. 2 also illustrates cases where auction prices are higher where there is a greater than 50% probability of sale.

Golf is a popular sport with origins in Scotland. People who play golf use golf clubs to hit balls into a series of holes on a golf course. The modern round of golf is 18 holes. A round of golf has not always been defined by an 18-hole round. In fact, many courses have or had fewer than 18 holes. Even today many golfers enjoy playing “a few holes” (9 holes or less). Playing a few holes is common at private (membership fee) clubs but less common at public venues (municipal and fee for play) because those venues often charge per round fees (daily fees) where those fees are traditionally for 18-hole rounds. An 18-hole round of golf normally takes between 4 to 5 hours to play with a 9 hole round talking approximately half that amount of time and therefore one hole a little less than 15 minutes. Golf is governed by the United States Golf Association (USGA) and the Royal and Ancient Golf Association (R&A).

According to the 2020 Golf Industry Report from the National Golf Foundation, in 2019 in the United States there were 36.9 million golfers (aged 6+) who played 502 million rounds of golf. Those rounds were played at 16,100 (approximately 1 per 20,465 persons and 31,180 rounds per course) golf courses of which 75% are public (daily fee) at an average price of $61 for an 18-hole round and $33 for a 9-hole round. Based on this fact pattern, U.S. public golfers spent about $20 billion on round-based (daily) fees in 2019 to play golf at public venues.

Golf is also popular internationally. According to research from the R&A, there are approximately 39,000 courses in the world. The game is popular in many international countries and especially popular in Japan, the United Kingdom, and Australia. For example, the United Kingdom has 883,500 golfers who play golf at 1,888 golf courses (approximately 1 per 35K persons). Like in the U.S., the R&A report shows that 75% of courses are open to public fee per round. It may be assumed that the international rate is not lower than the U.S. rate ($61) and that international rounds per course are higher. Given that, the total addressable market (TAM) for fee for play golf could be $56 billion (39,000×75%×31,180×61) USD or more. This TAM is based on the inventories that sell today, not the maximum potential spending if all inventories sold with demand to pay for those inventories

Since the COVID pandemic, the popularity of the sport has been rising in terms of participants and rounds played, by double digits. The report referenced above from the National Golf Foundation reports that golf rounds were up 14% over 2019. In addition, a February report by Sports Marketing Surveys reported that rounds of golf played in Great Britain increased by 12%.

Daily fee prices are currently set with standard rates based on a variety of factors corresponding to quality of the facility and demand for the facility including, but not limited to, season of the year (e.g. rates are lower in Arizona in the summer when it's too hot for many to play the game), day of the week (e.g. there is more demand on weekends), time during the day (e.g. morning times have more demand given the length of time it takes to play a round). Courses differentiate between prices even during peak times. Daily fee facilities commonly offer “twilight” discounted rates. These rates are discounted compared to the 18-hole round rates. These discounts range between 10-33%.

Daily fee tee time inventories are primarily sold online today. Online web sites aggregate daily fee inventories and offer those at prices set by the golf courses. Those sites get a fee for selling the golf course inventory because they typically have a wider reach than golf course-run websites. These aggregator sites do not take inventory risk (i.e. they are not responsible for the “cost” of unsold inventory). Therefore, it may be assumed that their revenue recognition is for their net fees, not the total cost of the round. Golf courses almost always (because they do not pay fees if they sell their inventories listed there) have their own websites where they sell their inventories typically at the same prices one finds on aggregator web sites. Golf courses with high demand sell all of their inventory exclusively through their website or through other channels where they do not pay fees. To a limited degree, for courses with lower online demand, golf courses also take tee times by phone and put those into their tee sheets. Still, a large number of opportunities are lost for sales of tee times and other event access due to inefficiencies in the prior approaches.

As noted above, the average daily fee for 18 holes in the U.S. is $61, according to the National Golf Foundation. There is significant variance in these prices, however—upward variance. For example, a representative high demand golf course may require a stay at one of their hotels to play golf on their facilities. A hotel stay a basic room at such a location, per night, may range from $870-$1,150, and deluxe accommodations may range up to $7,860. A round of golf at such a location may cost $575 for resort guests with a required caddie fee minimum of $95+tip. In other words, s minimum full cost for a round at such a high-demand location may be upwards of $1,600 including these costs, tips, lunch, etc., and that price scales up approximately $7,000 for the deluxe room guests for a total of $8,600 per round. Assuming that such a representative high-demand golf course has limited availability on a certain date but no availability on the days surrounding this date, and only three days with limited availability nearly 50 days out, it may be assumed of such a golf course, that: 1) they will sell out ALL of their inventory including the $8,600 inventory, and 2) they could actually sell their inventory at higher prices than these prices given their demand if they were to auction their inventories. For many, this may be expensive, but the fact is, there are a lot of people in this world who do not care about price—they want to play where they want when they want, and they do not care what it costs to do so.

There is a significant amount of unsold inventory at daily fee facilities. This is because of a variety of factors including, but not limited to: unsold inventories are not discounted enough to clear inventory even at high demand locations; current pricing is often set based on 18-hole pay for play pricing discounts even though the tee times the courses offer discounts golfers cannot play 18-hole fee for play rounds; and excess lower demand inventories are not offered for sale by golf courses because of perceived low demand.

There is needed, therefore, systems and methods to address the above-referenced deficiencies. There is also needed a system to manage inventories with a goal of reducing wasted or unused assets and maximizing return on investment.

### SUMMARY

The following summary of the invention is exemplary and explanatory only and is not necessarily restrictive of the invention as claimed. It should be noted that in various embodiments, description is made with reference to figures. However, certain embodiments may be practiced without one or more of these specific details, or in combination with other known methods and configurations. In the following summary and detailed description, numerous details are set forth, such as specific configurations, dimensions and processes, etc., in order to provide a thorough understanding of the present invention. In other instances, well-known processes and conventional hardware have not been described in particular detail in order to not unnecessarily obscure the present invention. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “an embodiment,” or the like in various places throughout this specification are not necessarily referring to the same embodiment of the invention. Furthermore, the particular features, structures, configurations, or characteristics may be combined in any suitable manner in one or more embodiments. Example embodiments may address at least the above problems and/or disadvantages and other disadvantages not described above. Also, example embodiments are not required to overcome the disadvantages described above, and may not overcome any of the problems described above.

The system and method described herein provides a solution to dispose of significantly more inventories than are sold by prior approaches, such as those identified in the Background section herein. Example processes described herein can apply to any one of these categories where pricing is inefficient to capture maximum prices and to clear available inventory above marginal costs.

Industries and categories where the system and method could be applied include, but are not limited to, those categories itemized below. The system and method described herein can apply especially well to certain categories of goods (e.g., luxury goods); however, any types of goods or services may be utilized in concert with aspects of the present invention. In the case of goods, certain goods do not meet specific item characteristics (e.g., goods are not sold primarily online, supply may not be scarce enough, etc.) but in some situations those categories of goods could also be significant additional addressable revenue depending on the threshold transition of the asset disposition process, in addition to other factors. Example industries and categories that are particularly well-suited to be utilized with aspects of the present invention include, without limitation:

Transportation: Space, air, rail, ground where consumers or businesses pay fees for those services including, but not limited to, personal and business travel and transportation for freight and shipping.

Hospitality (Travel Accommodations): Accommodations for personal or business travel including, but not limited to, hotels, motels, vacation rentals, bed and breakfast and hostels, cruise lines, campgrounds.

Travel Services: Travel agent services and tour operator services.

Concerts & Events: Fees paid for live performances by artists including, but not limited to, popular music genres (e.g., rock, country, etc.), performing arts (e.g., dance, theatre, etc.), sports (e.g., professional football, baseball, soccer, hockey, golf, etc.), exhibitions, and events.

Daily Use Fees: Fees paid by consumers to use a venue, including but not limited to, sports (e.g., golf tee times, golf range facilities, bowling, etc.) and amusement parks (e.g., Disney, Six Flags, etc.).

Luxury Goods: Prices paid for consumer goods including but not limited to cars (e.g., Porsche, Lamborghini, etc.) and personal use goods (e.g., LVMH bags, Tiffany jewelry).

One or more example embodiments may provide an innovative multi-step process that may provide higher prices for high-demand goods and services and for lower demand goods and services to sell at pricing that may exhaust all demand for inventory at prices above marginal cost.

More particularly, in one embodiment, a method of the present invention comprises identifying an inventory of assets to be transferred through a multi-stage process; designating a first set of the assets for ownership transfer through a first offer process; presenting the first set of assets for purchase by a first designated recipient group through the first offer process; establishing a cut-over point to a second offer process, the cut-over point determined by a pre-determined criterion; presenting unpurchased assets of the first set of assets for purchase to a second designated group of recipients; and transferring ownership of the first set of assets to the purchasing recipients of the first and second groups. There may be any desired number of stages, such as two or more stages in the exemplary process. The set of assets may comprise a subset of the assets to be transferred, or may comprise the entire inventory. The pre-determined condition may comprise a period of time that is established before the first stage of sales transfers to a second stage, or may comprise a rate of sale over time criterion, a remaining inventory criterion, a demand-based criterion, or any other desired factor that establishes the cut-over point to provide maximal profits from disposing of the assets in a desired timeframe. Further, the first and second designated groups of recipients may comprise the same or different groups of intended purchasers, and may comprise, respectively, members of the general public or targeted groups of purchasers, or any combination thereof.

There is also provided, in various embodiments, a system comprising a primary device comprising mobile device, the primary device comprising: a processor in communication with a memory; a user interface in communication with the processor, the user interface including a touch-sensitive display and a data entry interface; a communications module in communication with the processor and configured to provide a communications interface to a third-party server, the third-party server further including a database, a server processor and a server memory; wherein one or more of the memory of the primary device or the server memory includes instructions that when respectively executed by the processor or the server processor perform the steps of: identifying an inventory of assets to be transferred through a multi-stage process; designating a first set of the assets for ownership transfer through a first offer process; presenting the first set of assets for purchase by a first designated recipient group through the first offer process; establishing a cut-over point to a second offer process, the cut-over point determined by a pre-determined criterion; presenting unpurchased assets of the first set of assets for purchase to a second designated group of recipients; and transferring ownership of the first set of assets to the purchasing recipients of the first and second groups. There may be any desired number of stages implemented by the instant system, such as two or more stages in the exemplary process. The set of assets may comprise a subset of the assets to be transferred, or may comprise the entire inventory. The pre-determined condition may comprise a period of time that is established before the first stage of sales transfers to a second stage, or may comprise a rate of sale over time criterion, a remaining inventory criterion, a demand-based criterion, or any other desired factor that establishes the cut-over point to provide maximal profits from disposing of the assets in a desired timeframe. Further, the first and second designated groups of recipients may comprise the same or different groups of intended purchasers, and may comprise, respectively, members of the general public or targeted groups of purchasers, or any combination thereof.

### BRIEF DESCRIPTION OF THE DRAWINGS

A more complete understanding of the present invention may be derived by referring to the detailed description and claims when considered in connection with the following illustrative figures.

FIG. 1 illustrates a prior art graph showing supply and demand in online markets with inefficient pricing models.

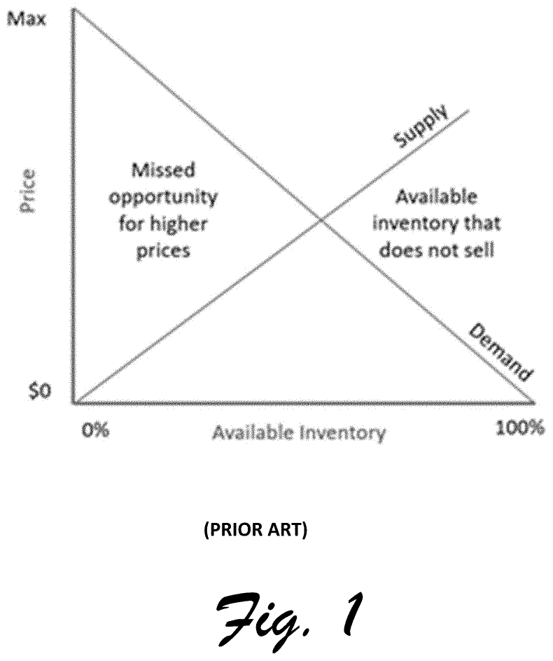

FIG. 2 provides a prior art illustration showing where auction prices are higher where there is a greater than 50% probability of sale.

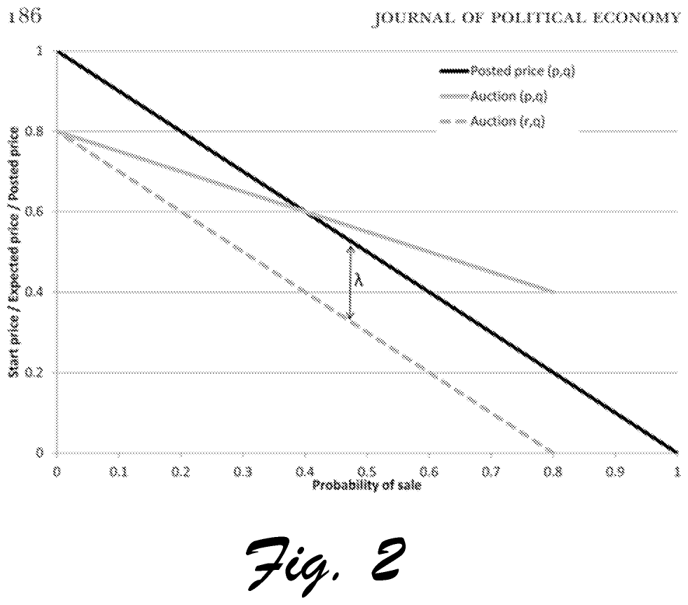

FIG. 3 provides a process flow of the present invention, illustrating an exemplary auction process.

FIG. 4 provides another aspect of process flow of the present invention describing an exemplary auction process.

FIG. 5 provides a diagram of an embodiment of a system of the present invention.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list. In addition, the terms such as “unit,” “-er (-or),” and “module” described in the specification refer to an element for performing at least one function or operation, and may be implemented in hardware, software, or the combination of hardware and software.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

A process according to one or more example embodiments may be applied to any of a number of scenarios and business models. Two example business models are: a model in which prices are very (materially) inefficient; and a model in which prices are marginally inefficient.

Where prices are very (materially) inefficient: The golf case study below describes this application below for the golf course tee time category. In this case, an online website according to an example embodiment would acquire 100% of the tee time inventory from golf course operators and resell that inventory at substantially higher prices and may sell significantly more inventory than is sold today, possibly increasing the profit golf course operators make and also possibly increasing the inventory sold so that more people can enjoy the game.

Where prices are marginally inefficient: In this case, the category pricing models are much more efficient and dynamic. Take goods and services sold by an online retailer or hotel rooms sold on an online auction. The pricing models these firms use are much more sophisticated and the margin potential is less. In those scenarios, a license model may be the best model to employ and leverage an example process according to one or more example embodiments.

Process Description

Stage 1: Run a reserve price auction to clear the high demand inventory at maximum prices. Set an auction end date to correspond to the time when demand is high (probability of sale >50%) to clear most of the inventory. The auction end date could be set as far back as 2 years or as close as 5 minutes.

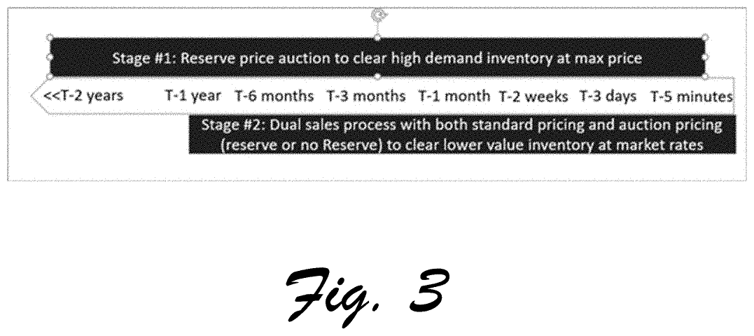

Stage 2: Run a dual sales process where remnant inventories are available for sale at prices above marginal costs (very low prices). These inventories could be available for sale at standard prices (as they are sold today) or through a reserve (marginal cost) or no reserve (no variable costs) auction. This process could run from the stage #1 auction end date until the good or service is sold or demand is exhausted. These stages are illustrated in the exemplary auction process of FIG. 3.

One or more example embodiments described herein may provide a higher prices for high-demand tee times and lower prices for lower demand inventory and an increase in the amount of tee time inventory that will sell. Features of an example embodiment are described below:

An online web site according to an example embodiment may increase golf course operator revenue for golf course operators by paying them a higher price (e.g. a percentage increase on their prior year revenues+annual inflationary increases) than they earn today for their inventory. This increase may motivate operators to move to capture the reward.

The example online website, referred to hereinafter as “NewCo.,” may take the risks and rewards by purchasing all the daily fee inventory from the operators and reselling it on the NewCo website.

NewCo may sell nearly 100% of available inventory at high-demand golf properties. Golf daily fee consumers will be able to name their price for golf when they bid for golf in the NewCo online auction. This will include inventory not sold today so they can play 9 holes (or less) at lower prices than are available today.

The NewCo website may employ an auction process according to one or more example embodiments described herein in order to enable achievement of a maximum price that daily fee consumers are willing to pay for high demand tee times and may make a significant margin over the amount of compensation paid to the golf course operator for their inventory.

Taken together, Newco may own and sell nearly 100% of the golf course inventory in markets where it operates because golf course operators may want higher rents and golf tee time consumers may want to buy all the inventory if they can name their own price. Newco may recognize this revenue and may make a margin because they are both raising prices and selling a much higher percent of available inventory, according to one or more example embodiments.

Golf Process Description

Four features of an example embodiment are described below:

Increase Golf Course Operator Revenue: Golf course operation can be big business. Take an example golf course A having a very high ranking in state A. In terms of daily fee only, example golf course A may be a top 5 course in state A. Given this high ranking, golf course A may be a destination course for visitors and residents in the area. An analysis of golf course A may show that a high price offered for tee times is $323 per 18-hole round. An example average fee per round may be $209; however, golf course A may offer twilight rates that do not actually sell and the rates for those times may be materially lower distorting this average. A representative average rate for the inventory golf course A sells may be around $275 per round. Their average rate for the seven months from October to April may be estimated at approximately $250. In the summer, they discount their rates to correspond to lower demand. Their average summer (May-September) time rate may be around $125 per round. Given this information, their weighted average rate may be close to $200 per 18-hole round. They may offer an average of 60 tee times per day for four players each tee time. They may only sell about 70% of their available inventory. If these assumptions are correct, golf course A has potential inventory to sell of 61,250 tee times at a current average rate of $200 that's $12.25M in fee for play revenue. If NewCo guaranteed them a 5% increase (for illustration only) on their revenues by buying their inventory they could increase their profit by approximately $600 thousand. If golf course A operates 13 courses in its region, and about 700 courses, in total, including daily fee and membership courses globally, if that number is multiplied by just those 13 courses where Newco could pilot, that would be profit in the $7.5M range. Management at such a golf course might be interested in this sort of increase to their profit (this is almost 100% profit vs. otherwise potentially low margins) enough that they could move their inventory for a local area-based pilot, at least (or Newco could negotiate to a number that would move them).

Take all risks and rewards: This strategy serves three major purposes. First, the golf course operators may want a guaranteed and financially significant (material) price to move their inventory off their website and off the aggregator websites with whom they may have contractual relationships they may need to exit. According to an example embodiment described herein, pricing may remain opaque to golf course operators. If course operators were to gather intelligence about prices golf consumers are willing to pay for specific time slots during the day/time of year, they might choose to go back to their standard online pricing structure with this new price data. By purchasing the inventory and talking the risks, a website according to an example embodiment could potentially recognize 100% of the tee time revenue, which would give the website the opportunity to be >$56 billion dollar (larger because a significant amount of inventory is unsold today and if that is say 25%, then the real TAM is more like $75B) company based on the TAM calculated above with potentially double-digit profit margins.

Sell nearly 100% of available inventory: Even high-demand golf courses do not sell a significant amount of their inventory. Lower demand courses do not even try in some cases. Take example golf course B. The last tee time golf course B offers during the peak of the peak season is 2 PM whereas golf course A may over tee times until 4:30 PM—that's 60 tee times or about a 25% increase in their inventory available to sell (and they do not sell all of their high value inventory so it's actually a much higher percentage for them). Golf course B may shut down their golf course from July to September. Considering these factors together (i.e. golf course B does not offer all their inventory, do not sell all they offer, and are closed for two months), it may be estimated that they could have >50% more inventory available to sell. True, they may have lower demand, however, it is possible that they could clear most if not all their inventory because people would love to play golf course B for the right price. A problem, however, may be that a golf course wants too much money per round for lower demand inventory and that inventory doesn't clear (supply and demand do not intersect at those price points). If daily fee golfers could name their own price for a round, it is possible that nearly 100% of golf course B tee time inventory could clear. According to an example embodiment, Newco could possibly give them a meaningful amount to require them to stay open and still make a significant profit from the upside of selling out the inventory.

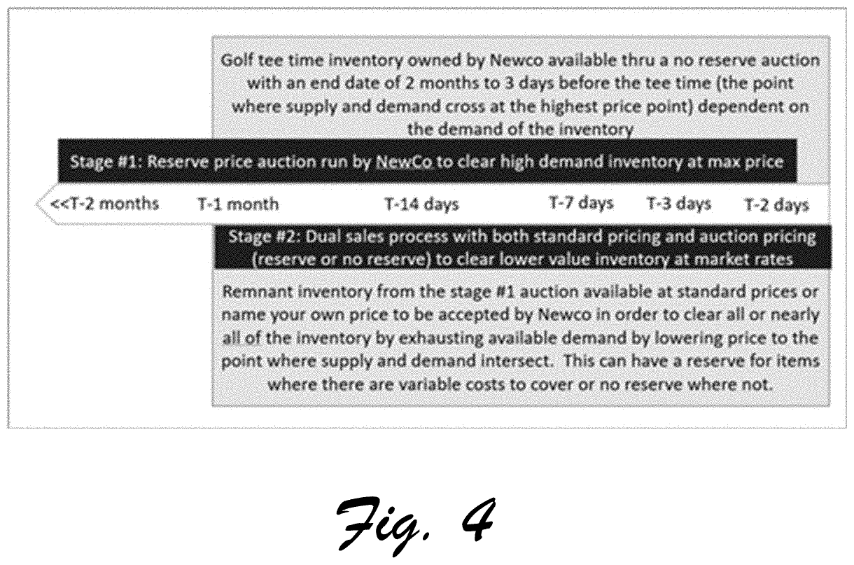

Exemplary auction process of the present invention: Different from auctions in which the auction sells at standard rates first and then auctions the low value remnant inventory, a tee time auction process according to an example embodiment would run first as a no reserve auction rather than selling times at standard rates. Auction end dates could vary and could be set by Newco to end based on where maximum demand and auction participation would occur—up to two months before the tee time or as late as 3 days prior to the tee time. For high demand properties, there could be sufficient demand at tee time minus 1 month. However, for lower demand properties, the auction end date could be much closer to the tee time (perhaps as close as 3 days). After a first auction ends, the remnant inventory could clear and could be offered for sale in either of two ways: 1) at regular standard prices in the same manner as they may be offered on golf operator web sites, or 2) through a name your price auction where prices would be accepted to clear the inventory. NewCo could also offer the golf course operators inventory on its website and could also offer a plug in for golf course operators to include on their website (without providing them access to pricing information). Operators could be provided with access to the tee sheet (again without pricing) and could be permitted to book tee times for golf consumers who call in at standard published prices. The golf operator could pay NewCo for this option. A visual depiction of the process is illustrated in FIG. 4.

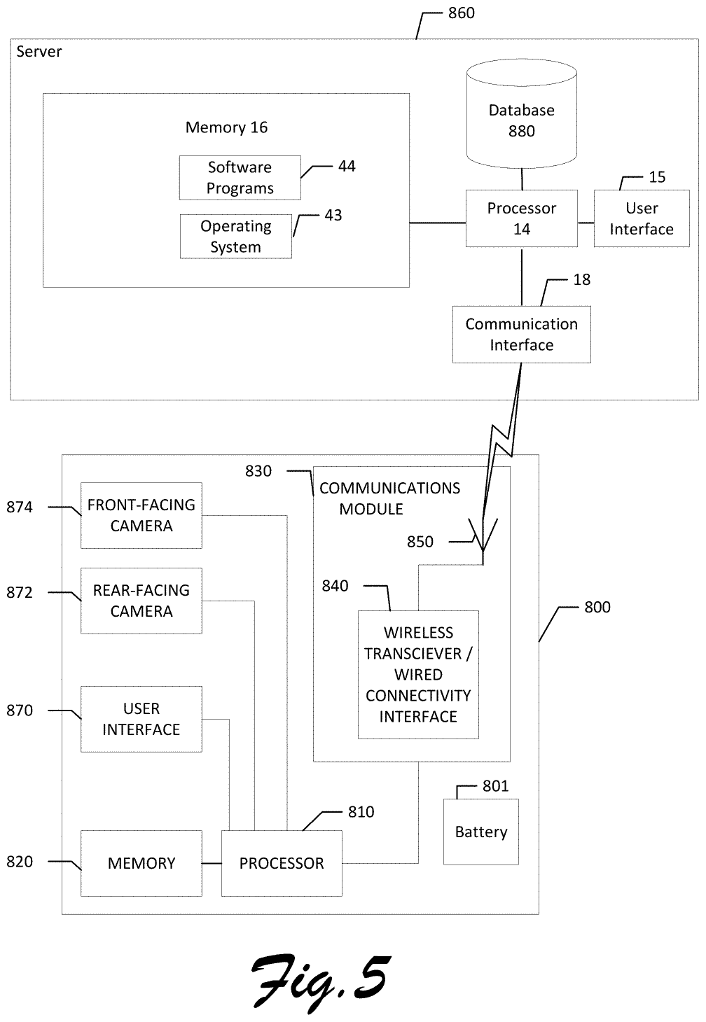

There is also presented an exemplary system depicted in FIG. 5, and in an embodiment comprises a mobile device 800 (which may comprise, in some embodiments, laptop computers, tablet computers, or other typically non-mobile devices such as personal computers, workstations, or terminals) one of primary device 100 or secondary devices 150, 160, 165) that includes a processor 810 coupled to a memory 820 which may include volatile memory, nonvolatile memory (such as FLASH memory) or a combination thereof. A communications module 830 comprises a wireless transceiver 840 for wirelessly communicating with one or more servers, such as host server 860 and other entities through antenna 850, although those of skill in the art may appreciate that a wired connection may be established to provide connectivity in lieu of or in addition to the wireless connection. The mobile device 800 also includes a user interface 870 coupled to the processor 810. The mobile device 800 may include any suitable power source, such as a battery 801. The mobile device 800 may include any other desired components, such as a global positioning system (GPS) to provide geolocation information for locating the mobile device. Some or all of the components of the mobile device 800 may include (or be in communication with) a hardware identification module (not shown) such as a universal subscriber identity module and/or removable user identity module. The hardware identification module may be coupled to the processor 810 and may include an identifier that can be compared to a predetermined identifier to determine whether the hardware of the mobile device 800 has been altered. The hardware identification module (and predetermined identifier) may include any suitable identifier, such as an electronic serial number, a local area identity identifier, an integrated circuit identifier, an international mobile subscriber identifier, an authentication key identifier, and/or an operator-specific emergency number identifier. The identifier may be stored in the memory 820 and transmitted to the host server 860 for comparison to a predetermined identifier.

The functionality of the mobile device 800, including the methods described herein (in whole or in part), may be implemented through the processor 810 executing computer-readable instructions stored in the memory 820 of the mobile device 800. The memory 820 may store any computer-readable instructions and data, including software applications, user-installed or third-party-installed “apps,” applets, and embedded operating code.

Software performing methods of the present invention may be provided with the device or downloaded onto the mobile device by an authorized user, and/or may be further resident in memory 16 of the host server 860 and executable by the server processor 14. The functionality of the mobile device 800 as well as the host server 860 may also be implemented through various hardware components storing machine-readable instructions, such as application-specific integrated circuits (ASICs), field-programmable gate arrays (FPGAs) and/or complex programmable logic devices (CPLDs), graphics processing units (GPUs), and neural network processing or simulation circuits. Systems according to aspects of the present invention may operate in conjunction with any desired combination of software and/or hardware components.

The processor 810 retrieves and executes instructions stored in the memory 820 to control the operation of the mobile device 800. Similarly the server processor 14 retrieves and executes instructions stored in the server memory 16 to control the operation of the host server 860. Any number and type of processor such as an integrated circuit microprocessor, microcontroller, and/or digital signal processor (DSP), can be used in conjunction with the present invention. The memory 820 stores instructions, data, messages transmitted from (or received by) the mobile device 800, and any other suitable information, and the server memory 16 similarly stores instructions, data, messages transmitted from (or received by) the host server 860, and any other suitable information. A memory 820 and server memory 16 operating in conjunction with the present invention may include any combination of different memory storage devices, such as hard drives, random access memory (RAM), read only memory (ROM), FLASH memory, or any other type of volatile and/or nonvolatile memory. Data can be stored in the memory 820 or server memory 16 in any desired manner.

The communications interface 830 communicates with one or more servers such as host server 860, or other suitable entities. In like manner, the communication interface 18 of the host server is configured to communicate with the mobile device 800, a general network such as the Internet, or any other suitable entity. Any suitable communications device, component, system, and method may be used in conjunction with the present invention. For example, the wireless transceiver 840 may be configured to communicate using any number and type of cellular protocols, such as General Packet Radio Service (GPRS), Global System for Mobile Communications (GSM), Enhanced Data rates for GSM Evolution (EDGE), Personal Communication Service (PCS), Advanced Mobile Phone System (AMPS), Code Division Multiple Access (CDMA), Wideband CDMA (W-CDMA), Time Division-Synchronous CDMA (TD-SCDMA), Universal Mobile Telecommunications System (UMTS), and/or Time Division Multiple Access (TDMA). A mobile device operating in conjunction with the present invention may alternatively (or additionally) include wireless transceiver(s) (and related components) to communicate using any other method of wireless communication protocol, such as an ISO 14443 protocol, an ISO 18000-6 protocol, a Bluetooth protocol, a Zigbee protocol, a Wibree protocol, a WiFi protocol, an IEEE 802.15 protocol, an IEEE 802.11 protocol, an IEEE 802.16 protocol, an ultra-wideband (UWB) protocol; an IrDA protocol, and combinations thereof; and further, the communication interface 18 of host server 860 may be configured to operate with such protocols to communicate with the mobile device 800 or any other device. The antenna 850 may be configured to transmit and receive any wireless signal in any format, and may comprise a plurality of different antennas to transmit and receive using different wireless protocols.

The communications module 830 can communicate with the server 860 or another device using any other form of connection, such as a wired Internet connection, a wireless Internet connection, a cellular telephone network connection (including a data link connection), a wireless LAN connection, a wireless WAN connection, an optical connection, a Firewire connection, Thunderbolt connection, a Lightening port connection, an e-SATA connection, a USB connection, a mobile device synchronization port connection, a power connection, and/or a security cable. The communications module 830 can be used to communicate with one or more companion devices to monitor the position or status of the mobile device 800 (e.g., by monitoring whether a communication link between the mobile device and companion device is intact), as well as with any number of other devices to help track/locate a lost or stolen mobile device 800.

The mobile device 800 includes a user interface 870. The user interface 870 may include any number of input devices (not shown) to receive commands, data, and other suitable input from a user, as well as any number of output devices (not shown) to provide the user with data, notifications, and other suitable information from the mobile device 800. Likewise, the host server 860 includes user interface 15, and may include any number of input devices (not shown) to receive commands, data, and other suitable input from a user or third party, as well as any number of output devices (not shown) to provide the user/third party with data, notifications, and other suitable information from the host server 860.

Any number of input devices may be included in the user interfaces 870, 15 such as touch pads, touch screens, a mouse/trackball/trackpad, a microphone, and/or an alphanumeric keypad to allow a user to enter instructions and data into the mobile device 800 and host server 860. The term “touch screen” for purposes of the present application may include a display integrated with or in close proximity to a touch interface that is capable of determining when a user applies physical connection to a location proximate the display. The touch screen may have sensors that can measure parameters from the user's interaction, and such sensors may measure capacitance, resistance, pressure, or differential readings resulting from movement of a “touch” to the screen. The user interface 870 may be configured to detect pressure exerted by a user on the keys of a keypad (virtually implemented on the display, or as a physical array of key switches), as well as the time interval between key presses in order to determine if the current user is authorized to use the device. The user interface 870 may also include a microphone to allow the user to provide audio data to the mobile device 800, as well one or more cameras to allow the mobile device to capture still or video images. Similarly, the user interface 15 of the host server 860 may include a microphone to allow a user to provide audio data to the host server 860, as well one or more cameras to allow the server 860 to capture still or video images. In one embodiment, the mobile device 800 comprises a front-facing camera 874 that faces the user when the device is in operation, and a rear-facing camera 872 on an opposite side of the mobile device. The mobile device 800 may include speech recognition software to process verbal input through the user interface 870. The user interface 870, and similarly the server user interface 15 may also include any number of suitable output devices, such as a display screen to visually display information (such as video and text), and/or a speaker to provide auditory output. The display of the mobile device may be configured to sense user touches by any appropriate means, such as capacitive sensing, pressure sensing, gel displacement sensing, resistive sensing, or any other appropriate or conventional touch sending technology utilized by those of skill in the relevant arts. The mobile device 800 may be configured to provide words, phrases, tones, recorded music, or any other type of auditory output to a user through the speaker.

The mobile device 800 may include one or more biometric devices configured to receive biometric information, such as a fingerprint scanner, an iris scanner, a retinal scanner, and/or a breath analyzer. Input devices such as a microphone or camera may also be utilized to perform biometric analyses, such as a voice analysis or facial recognition. Further, the mobile device may include a magnetometer for measuring magnetic fields (such as may be utilized in an electronic compass), a MEMS or other type of gyroscope for measuring attitude, and accelerometers for measuring changes in movement of the mobile device.

Information provided or received by the user interfaces 870, 15 may be in any appropriate format. For example, a user interface that communicates information to a user in an auditory format may first provide a data header followed by a data value to identify the data to the user. The user interfaces 870, 15 may provide information in any number of desired languages, regardless of whether the information is provided audibly or visually.

The user interfaces 870, 15 can also provide/receive information to a user in a machine-readable format. In one exemplary embodiment of the present invention, for example, the user interface 870 of a mobile device 800 may send and receive messages using dual-tone multi-frequency (DTMF) tones. The mobile device 800 and host server 860 can be configured to send, receive, and process machine-readable data in any standard format (such as a MS Word document, Adobe PDF file, ASCII text file, JPEG, or other standard format) as well as any proprietary format. Machine-readable data to or from the user interfaces 830, 15 may also be encrypted to protect the data from unintended recipients and/or improper use. In an alternate embodiment, a user must enter a passcode to enable use of some or all of the functionality of the mobile device 800. Any other user interface feature may be utilized to allow a human or non-human user to interact with one or more devices operating in conjunction with the present invention.

The mobile device 800 may include any other suitable features, components, and/or systems. For example, the mobile device 800 may be configured to preserve the life of its battery by shutting off some or all of its components, such as a camera or microphone. Alternately, the mobile device 800 can be configured to use its components excessively to drain the battery as quickly as possible, to, for example, limit the usefulness of the mobile device 800 to an unauthorized user.

The mobile device 800 may be configured to implement one or more security measures to protect data, restrict access, or provide any other desired security feature. For example, a mobile device 800 may encrypt transmitted data and/or data stored within or created by the device itself. Such security measures may be implemented using hardware, software, or a combination thereof. Any method of data encryption or protection may be utilized in conjunction with the present invention, such as public/private keyed encryption systems, data scrambling methods, hardware and software firewalls, tamper-resistant or tamper-responsive memory storage devices or any other method or technique for protecting data. Similarly, passwords, biometrics, access cards or other hardware, or any other system, device, and/or method may be employed to restrict access to any device operating in conjunction with the present invention.

The host server 860 communicates with mobile devices 800, authorized users, unauthorized users, security authorities, and other entities to monitor and protect the mobile devices 800 from unauthorized use and to mitigate the harm associated with a security compromise event or attempted fraud. The host server 860 may comprise any number of separate computer systems, processors, and memory storage devices, and any other suitable entity. The host server 860 may include, or be in communication with, one or more databases 880 storing information regarding authorized users, assets to be auctioned/sold, and mobile devices 800 in order to monitor and track the mobile devices 800.

The host server 860 may receive, process, and store (e.g., in the database 880) information from the mobile device 800. The host server 860 may handle any type of data in any format to achieve any purpose, such as receiving and processing environmental parameters captured by the mobile device to track the position and location of the mobile device 800, such as upon a golf course or other venue of interest. The database 880 may also store location information that can be used to determine whether the mobile device 800 is operating in a valid location (e.g., “whitelisting” and “blacklisting” as discussed previously). The database 880 may also store neural network training data, wherein exemplary images of defects in mobile devices are correspondingly associated with identified defect classes, outputs or states. The neural network training data may be augmented or otherwise modified to improve accuracy of recognition of device defects. Further, database 880 may store results of analysis of the health and operation of mobile device 800, along with identifying information and historical operational information associate with mobile device 800. In this manner, operational analysis of the mobile device may be tracked and analyzed over time by server 860, and trends identified that may indicate pending failure of at least one component of mobile device 800.

Databases 880 in communication with the host server 860 may also store archived data from mobile devices 800 for recovery in the event the mobile devices 800 are lost or stolen, such as information regarding purchased assets, tokens, or tee-times; and the data may also be archived in the event that the data on the mobile device 800 is destroyed (e.g., by a virus or other malicious program). The functionality of the host server 860 may be performed automatically or semi-automatically, such as through software/hardware operating on one or more computer systems, and/or by one or more human operators.

The host server 860 may include one or more system processors 14 that retrieve and execute computer-readable instructions stored in a memory 16 to control (at least partially) the operation of the host server 860. Any number and type of conventional computer, computer system, computer network, computer workstation, minicomputer, mainframe computer, or computer processor, such as an integrated circuit microprocessor or microcontroller, can be used in conjunction with the present invention. Computer systems used in accordance with aspects of the present invention may include an operating system 43 (e.g., Windows NT/95/98/2000/XP/Vista/7/8/10/11 OS2, UNIX, Linux, Solaris, MacOS, etc.) as well as various conventional support software and drivers typically associated with computers. In certain embodiments, dedicated applications may be entirely or partially served or executed by the system processor to perform methods of the present invention.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the claims.

What is claimed is:

1. A method comprising:
identifying an inventory of assets to be transferred through a multi-stage process;
designating a first set of the assets for ownership transfer through a first offer process;
presenting the first set of assets for purchase by a first designated recipient group through the first offer process;
establishing a cut-over point to a second offer process, the cut-over point determined by a pre-determined criterion;
presenting unpurchased assets of the first set of assets for purchase to a second designated group of recipients; and
transferring ownership of the first set of assets to the purchasing recipients of the first and second groups.

2. A system comprising:
a primary device comprising mobile device, the primary device comprising:
a processor in communication with a memory;
a user interface in communication with the processor, the user interface including a touch-sensitive display and a data entry interface;
a communications module in communication with the processor and configured to provide a communications interface to a third-party server, the third-party server further including a database, a server processor and a server memory;
wherein one or more of the memory of the primary device or the server memory includes instructions that when respectively executed by the processor or the server processor perform the steps of:
identifying an inventory of assets to be transferred through a multi-stage process;
designating a first set of the assets for ownership transfer through a first offer process;
presenting the first set of assets for purchase by a first designated recipient group through the first offer process;
establishing a cut-over point to a second offer process, the cut-over point determined by a pre-determined criterion;
presenting unpurchased assets of the first set of assets for purchase to a second designated group of recipients; and
transferring ownership of the first set of assets to the purchasing recipients of the first and second groups.
